(19) United States
(12) Patent Application Publication
(10) Pub. No.: US 2025/0116287 A1
(43) Pub. Date: Apr. 10, 2025

(54) Connector and Furniture Using Connector

(71) Applicant: XILINMEN FURNITURE CO, LTD, Shaoxing, Zhejing (CN)

(72) Inventor: Dong TANG, Shaoxing, Zhejiang (CN)

(21) Appl. No.: 18/562,852

(22) PCT Filed: Mar. 21, 2023
(86) PCT No.: PCT/CN2023/082906

§ 371 Date: Nov. 21, 2023

(30) Foreign Application Priority Data
Jun. 29, 2022 (CN) 202221656943.6

(51) Int. Cl. F16B 12/10; F16B 12/54

(52) U.S. Cl. CPC F16B 12/10; F16B 12/54; F16B 2012/106

(57) ABSTRACT

The disclosure relates to a connector and furniture using connector. The disclosure includes a primary member and an auxiliary member that are separated and detachable. The primary member is provided with a primary junction having a limiting groove, and the auxiliary member is provided with an auxiliary junction having a limiting block. When the primary junction and the auxiliary junction are vertically stacked, the limiting block is vertically inserted into the limiting groove, such that the primary member and the auxiliary member are horizontally clamped and limited. The primary member and the auxiliary member are provided with the primary junction having the limiting groove and the auxiliary junction having the limiting block respectively, such that the primary member and the auxiliary member are fixed to each other in an inserted manner.

### CROSS-REFERENCE TO RELATED APPLICATION

The disclosure claims the priority to Chinese Patent Application No. 202221656943.6, filed to the China National Intellectual Property Administration on Jun. 29, 2022 and entitled “Connector and furniture using connector”.

### TECHNICAL FIELD

The disclosure relates to the field of furniture, and particularly relates to a connector and furniture using the connector.

### BACKGROUND

Existing furniture are assembled structures, which are convenient to stack, transport and store after being disassembled, but also can be assembled in a use site. During assembly, adjacent components are fixedly connected by connectors. An existing connector includes a primary member and an auxiliary member that are fixedly connected to the adjacent components separately. The primary member is provided with a fastener, and the auxiliary member is provided with a catching groove. The fastener is clamped into the catching groove, such that the adjacent components can be fixedly connected. Both the primary member and the auxiliary member are of sheet structures formed by bending metal sheets, and therefore, structural reliability is low, and use experience is influenced.

### SUMMARY

Some embodiments of the disclosure provide a connector and furniture with the connector. A primary member and an auxiliary member are provided with a primary junction having a limiting groove and an auxiliary junction having a limiting block respectively, such that the primary member and the auxiliary member are fixed to each other in an inserted manner. In this way, connection strength is effectively improved, and use experience is improved.

The disclosure is implemented as follows: a connector includes a primary member and an auxiliary member that are separated and detachable. The primary member is provided with a primary junction having a limiting groove, and the auxiliary member is provided with an auxiliary junction having a limiting block. When the primary junction and the auxiliary junction are vertically stacked, the limiting block is vertically inserted into the limiting groove, such that the primary member and the auxiliary member are horizontally clamped and limited. The primary member and the auxiliary member are provided with the primary junction having the limiting groove and the auxiliary junction having the limiting block respectively, such that the primary member and the auxiliary member are fixed to each other in an inserted manner. In this way, connection strength between the primary member and the auxiliary member can be improved by providing the primary junction and the auxiliary junction, and further rapid assembly can be achieved by vertically inserting the limiting block into the limiting groove, such that use experience is improved.

In some embodiments, the limiting groove is provided on a top surface of the primary junction, and the limiting block is arranged on a bottom surface of the auxiliary junction. The limiting block is vertically inserted into the limiting groove, such that an outer side wall of the limiting block abuts against an inner side wall of the limiting groove, and relative positions of the primary member and the auxiliary member in a horizontal direction are ensured to be fixed.

In some embodiments, the limiting block is inserted downwards into the limiting groove, and the primary member and the auxiliary member are assembled at an equal height. The primary member and the auxiliary member may be arranged at an equal height after insertion and assembly are completed in place, such that demand of the connector for a height of assembly space is effectively reduced. Specifically, after the limiting block is inserted into the limiting groove, a top edge of the primary member and a top edge of the auxiliary member are arranged at an equal height, and a bottom edge of the primary member and a bottom edge of the auxiliary member are arranged at an equal height.

In some embodiments, horizontal cross sections of the limiting block and the limiting groove have the same contour that is square, such that horizontal deviation and deflection between the limiting block and the limiting groove are limited. The limiting block is vertically inserted into the limiting groove, and surfaces of the limiting block and the limiting groove are matched with and attached to each other. In this way, horizontal limitation is achieved, and circumferential limitation is achieved in a horizontal plane. Further, it may be ensured that the auxiliary member may still be accurately inserted into the limiting groove by the limiting block after rotating by 90° or 180°, such that assembly and relative position adjustment between a primary plate and an auxiliary plate are facilitated, and requirement of different use scenes is satisfied.

In some embodiments, the connector includes a locking member. The primary member and the auxiliary member are fixedly connected to each other by the locking member after insertion is completed in place, such that vertical deviation between the primary member and the auxiliary member is limited. The locking member is configured to vertically fix the primary member to the auxiliary member, such that the limiting block is prevented from being vertically separated from the limiting groove, and vertical locking is achieved.

In some embodiments, the primary member extends outwards to form a primary joint, and the auxiliary member extends outwards to form an auxiliary joint. When the limiting block is vertically inserted into the limiting groove in place, the primary joint and the auxiliary joint are vertically stacked and fixedly connected to each other by the locking member. The primary joint and the auxiliary joint are vertically stacked, and the primary joint and the auxiliary joint are screwed and locked to each other by the locking member, such that relative positions of the primary member and the auxiliary member are ensured to be fixed, and space may be provided for mounting the locking member.

In some embodiments, the primary member includes the primary plate vertically arranged. The primary junction is arranged on a middle section of the primary plate. The primary joint is arranged on a bottom edge of the primary plate. A moving cavity allowing the auxiliary joint to be inserted into is formed between the primary junction and the primary joint. The auxiliary member includes the auxiliary plate vertically arranged. The auxiliary junction is arranged on a top edge of the auxiliary plate. The auxiliary joint is arranged on a bottom of the auxiliary plate. The primary plate and the auxiliary plate are configured to be connected to adjacent furniture components respectively, such that the adjacent furniture components may be spliced and fixedly connected by the connector. The primary junction is matched with the auxiliary junction in height, and the primary joint is matched with the auxiliary joint in height, such that the primary junction cooperates with the auxiliary junction while the primary joint cooperates with the auxiliary joint, and meanwhile the primary junction and the auxiliary junction do not influence the primary joint and the auxiliary joint. Further, it may be ensured that the auxiliary joint and the primary joint are matched with and attached to each other after the limiting block is inserted into the limiting groove, such that screwing and locking of the locking member are facilitated. The moving cavity provides space for horizontal insertion and vertical lifting of the auxiliary joint. It is ensured that the limiting block linked with the auxiliary joint may be vertically inserted into the limiting groove after horizontally moving to a position above the limiting groove. It is ensured that the auxiliary joint and the primary joint are vertically stacked after the limiting block is inserted in place. In this way, screwing and locking of the locking member are facilitated, and further it is ensured that the limiting block is vertically locked in the limiting groove.

In some embodiments a projection of the primary joint is coincident with a projection of the primary junction in a vertical direction, and a projection of the auxiliary joint is coincident with a projection of the auxiliary junction in a vertical direction. The primary member and the auxiliary member are capable of being switched between a right-angle connection state in which the primary plate is perpendicular to the auxiliary plate and a parallel connection state in which the primary plate is parallel to the auxiliary plate. Relative positions of the primary plate and the auxiliary plate are changeable, such that relative positions of the adjacent components may be adjusted as required, and further different use demand is satisfied.

In some embodiments, the limiting groove and the limiting block have a vertical insertion depth of A, the moving cavity has a height of B, the auxiliary joint has a thickness of C, and B≥A+C. The height of the moving cavity satisfies a vertical movement demand of the auxiliary joint when the auxiliary joint is linked with the limiting block. It is ensured that the limiting block may be inserted into the limiting groove smoothly.

In some embodiments, the primary joint is provided with a through hole that is vertically penetrative, and the auxiliary joint is provided with a screw hole opened downwards. After mounted in place, the locking member penetrates the through hole from bottom to top and is screwed and locked to the screw hole. The locking member penetrates the through hole and is screwed and locked to the screw hole, such that vertical deviation between the primary joint and the auxiliary joint is prevented.

In some embodiments, the locking member has a bolt at an upper part and a foot pad at a lower part; or, the locking member has a bolt at an upper part and a wing knob at a lower part. According to a position of the locking member, a bottom of the locking member may be provided with the foot pad that is convenient to lap-joint to the ground or the wing knob that is convenient to rotate only with a hand of a user. The locking member has a specific function of supporting, or assembling and disassembling only with hands and is convenient to use.

Furniture using the connector includes a first connection part and a second connection part that are detachable. The first connection part and the second connection part are fixedly connected to each other by the connector, such that the first connection part is fixedly connected to a preset position of the second connection part in a preset posture. The adjacent components of the furniture are assembled and spliced by the connector, such that assembly and disassembly efficiency of the furniture is effectively improved, storage and transportation are facilitated through assembly and disassembly, structural strength of the furniture after assembly is further ensured, and use experience is improved.

Some embodiments of the disclosure have beneficial effects as follows: the primary member and the auxiliary member are provided with the primary junction having the limiting groove and the auxiliary junction having the limiting block respectively, such that the primary member and the auxiliary member are fixed to each other in an inserted manner. In this way, connection strength between the primary member and the auxiliary member is improved through addition of the primary junction and the auxiliary junction, and further rapid assembly is achieved by vertically inserting the limiting block into the limiting groove, such that use experience is improved. In addition, the adjacent components of the furniture are assembled and spliced by the connector, such that assembly and disassembly efficiency of the furniture is effectively improved, storage and transportation are facilitated through assembly and disassembly, structural strength of the furniture after assembly is further ensured, and use experience is improved.

### BRIEF DESCRIPTION OF THE DRAWINGS

FIG. 1 is a schematic diagram of a disassembled structure of a connector according to Embodiment 1;

FIG. 2 is a schematic diagram of an assembled structure of a connector in a right-angle connection state according to Embodiment 1;

FIG. 3 is a schematic diagram of an assembled structure of a connector in a parallel connection state according to Embodiment 1;

FIG. 4 is a schematic diagram of an assembled structure of a furniture according to Embodiment 2; and

FIG. 5 is a schematic diagram of a disassembled structure of a furniture according to Embodiment 2.

In the figures: 1, primary member; 2, auxiliary member; 3, limiting groove; 4, limiting block; 5, locking member; 6, primary junction; 7, auxiliary junction; 8, primary plate; 9, auxiliary plate; 10, primary joint; 11, auxiliary joint; 12, moving cavity; 13, through hole; 14, screw hole; 15, foot pad; 16, wing knob; and 17, connector.

### DETAILED DESCRIPTION OF THE EMBODIMENTS

Substantive features of the disclosure will be further described below with reference to accompanying drawings and specific embodiments.

### Embodiment 1

The embodiment provides a connector.

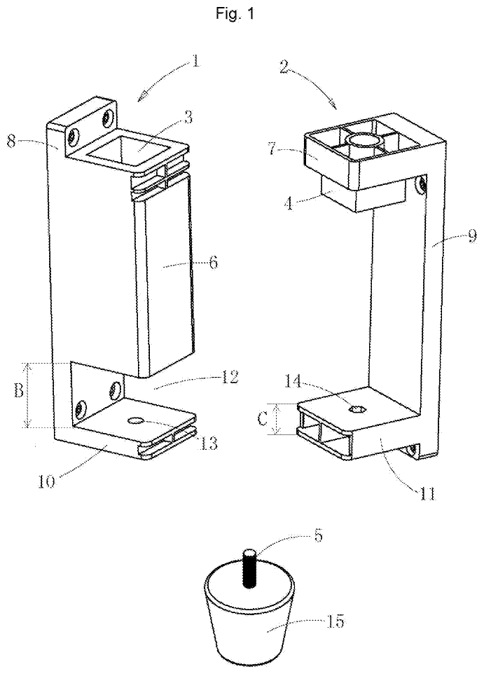

As shown in FIG. 1, the connector is composed of a primary member 1 and an auxiliary member 2 that are separated and detachable. The primary member 1 is provided with a primary junction 6 having a limiting groove 3, and the auxiliary member 2 is provided with an auxiliary junction 7 having a limiting block 4. When the primary junction 6 and the auxiliary junction 7 are vertically stacked, the limiting block 4 is vertically inserted into the limiting groove 3, such that the primary member 1 and the auxiliary member 2 are horizontally clamped and limited. The primary member 1 and the auxiliary member 2 are provided with the primary junction 6 having the limiting groove 3 and the auxiliary junction 7 having the limiting block 4 respectively, such that the primary member and the auxiliary member are fixed to each other in an inserted manner. In this way, connection strength between the primary member 1 and the auxiliary member 2 can be improved through addition of the primary junction 6 and the auxiliary junction 7, and further rapid assembly can be achieved by vertically inserting the limiting block 4 into the limiting groove 3, such that use experience is improved.

In some embodiments, the primary member 1 includes a primary plate 8 vertically arranged. The primary junction 6 is arranged on a middle section of the primary plate 8. A primary joint 10 is arranged on a bottom edge of the primary plate 8. A moving cavity 12 capable of allowing an auxiliary joint 11 to be inserted into is formed between the primary junction 6 and the primary joint 10. The auxiliary member 2 includes an auxiliary plate 9 vertically arranged. The auxiliary junction 7 is arranged on a top edge of the auxiliary plate 9. The auxiliary joint 11 is arranged on a bottom of the auxiliary plate 9. Smooth assembly of the primary member 1 and the auxiliary member 2 is ensured by rationally setting positions of the primary junction 6 and the primary joint 10 on the primary plate 8 and positions of the auxiliary junction 7 and the auxiliary joint 11 on the auxiliary plate 9. The connector is implemented during assembly through the following steps:

Firstly, a primary member 1 and an auxiliary member 2 are oppositely separated from each other, and a top surface of the primary junction 6 is lower than a bottom surface of the auxiliary junction 7. In this case, a height of the auxiliary joint 11 is flush with a top space of the moving cavity 12.

Then, the auxiliary member 2 is driven to move horizontally to the primary member 1, the auxiliary junction 7 moves horizontally to a position above the primary junction 6, and the auxiliary joint 11 moves horizontally to the top space of the moving cavity 12 and is located above the primary joint 10. In this case, a limiting block 4 is located above a limiting groove 3, and a through hole 13 is vertically aligned with a screw hole 14.

Then, the auxiliary member 2 is driven to move downwards, then the limiting block 4 is inserted downwards into the limiting groove 3, and the auxiliary joint 11 moves vertically in the moving cavity 12 and is attached to a top surface of the primary joint 10 after the limiting block 4 is inserted in place. In this case, an outer side wall of the limiting block 4 is closely attached to an inner side wall of the limiting groove 3, and the through hole 13 and the screw hole 14 move close to each other and are coaxial with each other.

Finally, a locking member 5 penetrates the through hole 13 from bottom to top and is screwed and locked to the screw hole 14.

After mounted in place, the locking member 5 is screwed and locked to the screw hole 14, such that the primary joint 10 and the auxiliary joint 11 vertically move close to each other and closely attached to each other. Further, the limiting block 4 is driven to be tightly inserted into the limiting groove 3 by the primary plate 8 and the auxiliary plate 9, such that the limiting block 4 is prevented from being vertically separated from the limiting groove 3, and locking and fixed-connection of the primary member 1 and the auxiliary member 2 are ensured.

In the embodiment, the limiting groove 3 is provided on a top surface of the primary junction 6, and the limiting block 4 is arranged on a bottom surface of the auxiliary junction 7. The limiting block 4 is inserted downwards into the limiting groove 3, and the primary member 1 and the auxiliary member 2 are assembled at an equal height. The primary plate 8 has an equal height to the auxiliary plate 9. After mounted in place, a top edge of the primary plate 8 is flush with the top edge of the auxiliary plate 9, and the bottom edge of the primary plate 8 is flush with a bottom edge of the auxiliary plate 9, such that a height of assembly space required when the connector is mounted is effectively reduced, and the connector is convenient to use.

In the embodiment, horizontal cross sections of the limiting block 4 and the limiting groove 3 have the same contour that is square, such that horizontal deviation and deflection between the limiting block 4 and the limiting groove 3 are limited. It is ensured that relative positions of the limiting block 4 and the limiting groove 3 after the limiting block is inserted into the limiting groove are fixed, deviation and deflection are prevented, and positioning reliability of the connector is ensured. The limiting block 4 may be inserted into the limiting groove 3 in a plurality of postures, such that relative positions of the primary plate 8 and the auxiliary plate 9 may be changed according to use demands.

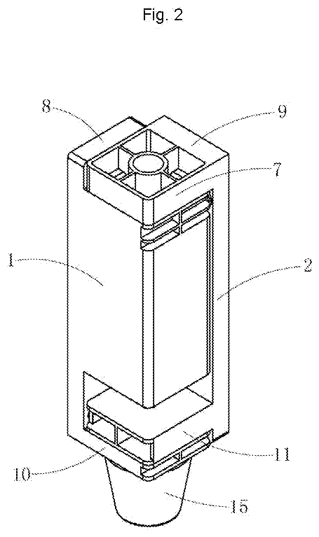

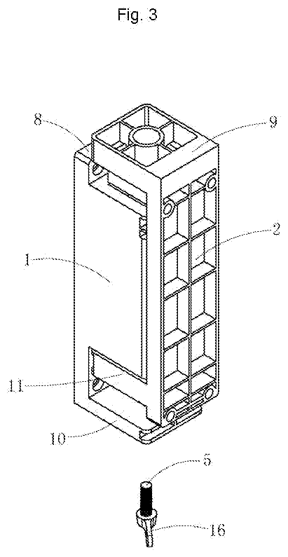

In the embodiment, a projection of the primary joint 10 is coincident with a projection of the primary junction 6 in a vertical direction and is square, and a projection of the auxiliary joint 11 is coincident with a projection of the auxiliary junction 7 in a vertical direction and is square. The primary member 1 and the auxiliary member 2 are capable of being switched between a right-angle connection state in which the primary plate 8 is perpendicular to the auxiliary plate 9 and a parallel connection state in which the primary plate 8 is parallel to the auxiliary plate 9. When the connector is in the right-angle connection state (as shown in FIG. 2), the primary plate 8 and the auxiliary plate 9 are perpendicular to each other and configured for mounting assembly objects perpendicular to each other. When the connector is in the parallel connection state (as shown in FIG. 3), the primary plate 8 and the auxiliary plate 9 are parallel to each other and configured for mounting assembled objects in parallel.

In the embodiment, the limiting groove 3 and the limiting block 4 have a vertical insertion depth of A, the moving cavity 12 has a height of B, the auxiliary joint 11 has a thickness of C, and B≥A+C. The auxiliary joint 11 and the auxiliary junction 7 are both fixedly connected to the auxiliary plate 9, such that relative positions of the auxiliary joint 11 and the auxiliary junction 7 are fixed, and the auxiliary joint and the auxiliary junction are matched and linked with each other. Assembly demand of the primary member 1 and the auxiliary member 2 is satisfied by rationally setting a height of the moving cavity 12. The height of the primary member 1 is controlled by reducing the height of the moving cavity 12, and further matched mounting of the primary member 1 and the auxiliary member 2 is ensured. Specifically, when a top surface of the auxiliary joint 11 is attached to a top wall of the moving cavity 12 for translation, a bottom surface of the limiting block 4 is able to move horizontally along a recess opening periphery of the limiting groove 3, such that it is ensured that the limiting block 4 may move horizontally to a position above the limiting groove 3 when the auxiliary joint 11 is moved into the moving cavity 12. When the auxiliary joint 11 moves downwards and a bottom surface thereof is attached to a top surface of the primary joint 10, the limiting block 4 is able to move downwards synchronously to be inserted into the limiting groove 3.

In some embodiments, the connector includes the locking member 5. The primary member 1 and the auxiliary member 2 are fixedly connected to each other by the locking member 5 after insertion is completed in place, such that vertical deviation between the primary member 1 and the auxiliary member 2 is prevented. Specifically, the primary member 1 extends outwards to form the primary joint 10, and the auxiliary member 2 extends outwards to form the auxiliary joint 11. When the limiting block 4 is vertically inserted into the limiting groove 3 in place, the primary joint 10 and the auxiliary joint 11 are vertically stacked and fixedly connected to each other by means of the locking member 5. The primary joint 10 and the auxiliary joint 11 are screwed and locked to each other by the locking member 5 after being vertically stacked and attached to each other. The locking member 5 vertically limits the primary joint 10 and the auxiliary joint 11, and further horizontally limits the primary joint 10 and the auxiliary joint 11.

In some embodiments, the primary joint 10 is provided with the through hole 13, the through hole 13 is vertically arranged, and the auxiliary joint 11 is provided with the screw hole 14 opened downwards. After mounted in place, the locking member 5 penetrates through the through hole 13 from bottom to top and is screwed and locked to the screw hole 14. The through hole 13 is provided in a center of the primary joint 10 and coaxial with the primary joint. The screw hole 14 is provided in a center of the auxiliary joint 11 and coaxial with the auxiliary joint. It is ensured that the through hole 13 may be vertically aligned with the screw hole 14 when the connector is in the right-angle connection state or the parallel connection state.

In some embodiments, the locking member 5 has a bolt at an upper part and a foot pad 15 at a lower part. The foot pad 15 is configured to support the connector and thus supports the furniture. In addition, as shown in FIG. 3, in some embodiments, the locking member 5 has the bolt at the upper part and may also have a wing knob 16 at a lower part; by increasing a surface area, the locking member 5 may be conveniently twisted only with hands by the user, and further assembly and disassembly operations may be facilitated, which should also be regarded as a specific embodiment of the example.

In the embodiments, the primary member 1 and the auxiliary member 2 are both made of plastic materials, and are integrally formed through injection molding, such that machining is facilitated, desirable structural strength is further achieved, and cost is effectively reduced.

### Embodiment 2

Compared with embodiment 1, some embodiments of the present disclosure provide a furniture.

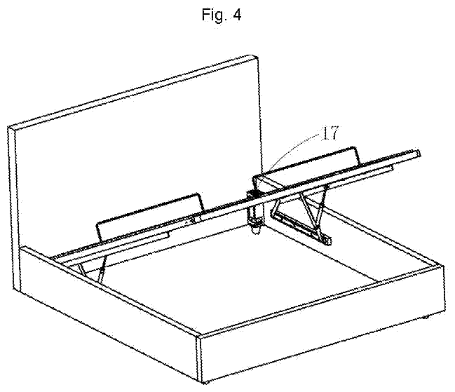

As shown in FIG. 4, the furniture includes a first connection part and a second connection part that are detachable. The first connection part and the second connection part are fixedly connected to each other by the connector 17 described above, such that the first connection part is fixedly connected to a preset position of the second connection part in a preset posture. With the connector 17, the first connection part and the second connection part that are adjacent to each other may be rapidly assembled and accurately fixed to each other, such that structural strength of the furniture is ensured, use demand is satisfied, and transportation and storage are achieved through rapid assembly and disassembly.

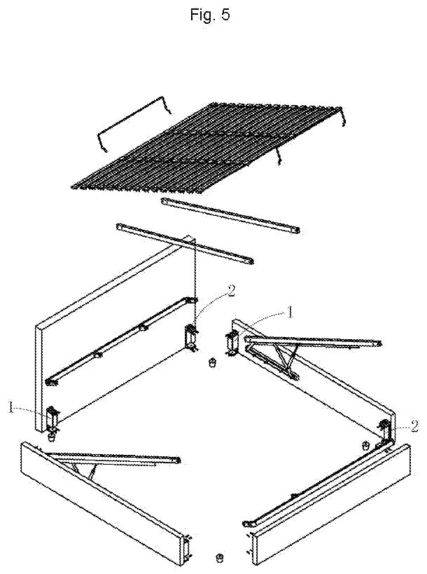

As shown in FIGS. 1 and 5, a primary member 1 is attached to a connection end of the first connection part by the primary plate 8 and fixedly connected by a fastener, such that the primary member 1 is fixedly connected to and linked with the first connection part. An auxiliary member 2 is attached to a connection end of the second connection part by the auxiliary plate 9 and fixedly connected by a fastener, such that the auxiliary member 2 is fixedly connected to and linked with the second connection part. After the primary member 1 and the auxiliary member 2 are matched with each other in an inserted manner and screwed and locked to each other by a locking member 5, the first connection part and the second connection part are spliced in a matched manner and firmly connected to each other, such that assembly and formation of the furniture are ensured.

In the example, the furniture includes at least two components. Under the condition of more components, the corresponding connector 17 may be arranged between adjacent components, such that assembly of the furniture is achieved. The first connection part and the second connection part do not specifically refer to specific components, and generally refer to adjacent components in the same furniture.

In the example, the furniture is a bed. In another example of the disclosure, the furniture may also be a sofa, a cabinet and other furniture that needs to be assembled and used with the connector 17 on site, which should also be regarded as a specific embodiment of the example.

Other structures and effects of the connector of the embodiments are the same as those of the connector of embodiment 1, which will not be described in detail.

What is claimed is:

1. A connector, comprising a primary member and an auxiliary member that are separated and detachable, wherein the primary member is provided with a primary junction having a limiting groove, the auxiliary member is provided with an auxiliary junction having a limiting block, and when the primary junction and the auxiliary junction are vertically stacked, the limiting block is vertically inserted into the limiting groove, such that the primary member and the auxiliary member are horizontally clamped and limited.

2. The connector according to claim 1, wherein the limiting groove is provided on a top surface of the primary junction, and the limiting block is arranged on a bottom surface of the auxiliary junction; or, the limiting block is inserted downwards into the limiting groove, and the primary member and the auxiliary member are assembled at an equal height.

3. The connector according to claim 1, wherein horizontal sections of the limiting block and the limiting groove have a same outer contour that is square, such that horizontal deviation and deflection between the limiting block and the limiting groove are limited.

4. The connector according to claim 1, comprising a locking member, wherein the primary member and the auxiliary member are fixedly connected to each other by the locking member after insertion is completed in place, such that vertical deviation between the primary member and the auxiliary member is limited.

5. The connector according to claim 4, wherein the locking member has a bolt at an upper part and a foot pad at a lower part; or, the locking member has a bolt at an upper part and a wing knob at a lower part.

6. The connector according to claim 4, wherein the primary member extends outwards to form a primary joint, the auxiliary member extends outwards to form an auxiliary joint, and when the limiting block is vertically inserted into the limiting groove in place, the primary joint and the auxiliary joint are vertically stacked and fixedly connected to each other by the locking member.

7. The connector according to claim 6, wherein the primary member comprises a primary plate vertically arranged, the primary junction is arranged on a middle section of the primary plate, the primary joint is arranged on a bottom edge of the primary plate, and a moving cavity allowing the auxiliary joint to be inserted into is formed between the primary junction and the primary joint; and the auxiliary member comprises an auxiliary plate vertically arranged, the auxiliary junction is arranged on a top edge of the auxiliary plate, and the auxiliary joint is arranged on a bottom of the auxiliary plate.

8. The connector according to claim 7, wherein a projection of the primary joint is coincident with a projection of the primary junction in a vertical direction, a projection of the auxiliary joint is coincident with a projection of the auxiliary junction in a vertical direction, and the primary member and the auxiliary member are capable of being switched between a right-angle connection state in which the primary plate is perpendicular to the auxiliary plate and a parallel connection state in which the primary plate is parallel to the auxiliary plate.

9. The connector according to claim 7, wherein a vertical insertion depth between the limiting groove and the limiting block is A, a height of the moving cavity is B, a thickness of the auxiliary joint is C, and B≥A+C.

10. The connector according to claim 6, wherein the primary joint is provided with a through hole that is vertically penetrative, the auxiliary joint is provided with a screw hole opened downwards, and after the primary member and the auxiliary member are mounted in place, the locking member penetrates the through hole from bottom to top and is screwed and locked to the screw hole.

11. A furniture, comprising the connector according to claim 1, wherein the furniture comprises a first connection part and a second connection part that are detachable, and the first connection part and the second connection part are fixedly connected to each other by the connector, the first connection part is fixedly connected to a preset position of the second connection part in a preset posture.

12. The furniture according to claim 11, wherein the limiting groove is provided on a top surface of the primary junction, and the limiting block is arranged on a bottom surface of the auxiliary junction; or, the limiting block is inserted downwards into the limiting groove, and the primary member and the auxiliary member are assembled at an equal height.

13. The furniture according to claim 11, wherein horizontal sections of the limiting block and the limiting groove have a same outer contour that is square, such that horizontal deviation and deflection between the limiting block and the limiting groove are limited.

14. The furniture according to claim 11, wherein the connector comprises a locking member, wherein the primary member and the auxiliary member are fixedly connected to each other by the locking member after insertion is completed in place, such that vertical deviation between the primary member and the auxiliary member is limited.

15. The furniture according to claim 14, wherein the locking member has a bolt at an upper part and a foot pad at a lower part; or, the locking member has a bolt at an upper part and a wing knob at a lower part.

16. The furniture according to claim 14, wherein the primary member extends outwards to form a primary joint, the auxiliary member extends outwards to form an auxiliary joint, and when the limiting block is vertically inserted into the limiting groove in place, the primary joint and the auxiliary joint are vertically stacked and fixedly connected to each other by the locking member.

17. The furniture according to claim 16, wherein the primary member comprises a primary plate vertically arranged, the primary junction is arranged on a middle section of the primary plate, the primary joint is arranged on a bottom edge of the primary plate, and a moving cavity allowing the auxiliary joint to be inserted into is formed between the primary junction and the primary joint; and the auxiliary member comprises an auxiliary plate vertically arranged, the auxiliary junction is arranged on a top edge of the auxiliary plate, and the auxiliary joint is arranged on a bottom of the auxiliary plate.

18. The furniture according to claim 17, wherein a projection of the primary joint is coincident with a projection of the primary junction in a vertical direction, a projection of the auxiliary joint is coincident with a projection of the auxiliary junction in a vertical direction, and the primary member and the auxiliary member are capable of being switched between a right-angle connection state in which the primary plate is perpendicular to the auxiliary plate and a parallel connection state in which the primary plate is parallel to the auxiliary plate.

19. The furniture according to claim 17, wherein a vertical insertion depth between the limiting groove and the limiting block is A, a height of the moving cavity is B, a thickness of the auxiliary joint is C, and B≥A+C.

20. The furniture according to claim 16, wherein the primary joint is provided with a through hole that is vertically penetrative, the auxiliary joint is provided with a screw hole opened downwards, and after the primary member and the auxiliary member are mounted in place, the locking member penetrates the through hole from bottom to top and is screwed and locked to the screw hole.
